(19) United States
(12) Patent Application Publication
(10) Pub. No.: US 2025/0163732 A1
(43) Pub. Date: May 22, 2025

(54) CLOSURE LATCH ASSEMBLY WITH MONO-DIRECTIONAL POWER RELEASE ACTUATOR HAVING SAFETY BLOCKING ARRANGEMENT

(71) Applicant: MAGNA CLOSURES INC., Newmarket (CA)

(72) Inventors: Marco TAURASI, Newmarket (CA); Francesco CUMBO, Newmarket (CA)

(21) Appl. No.: 18/949,982

(22) Filed: Nov. 15, 2024

Related U.S. Application Data
(60) Provisional application No. 63/602,346, filed on Nov. 22, 2023.
(60) Provisional application No. 63/602,351, filed on Nov. 22, 2023.

(51) Int. Cl. E05B 77/02; E05B 81/06; E05B 81/14; E05B 81/30; E05B 81/64; E05B 81/86

(52) U.S. Cl. CPC E05B 77/02; E05B 81/06; E05B 81/14; E05B 81/30; E05B 81/64; E05B 81/86

(57) ABSTRACT

A closure latch assembly includes a power release gear configured to be driven by a motor in a first direction from a home position to a release position, whereat a pawl releases a ratchet to permit the ratchet to move to a striker release position, and back to the home position in the first direction, whereat a sensor signals the motor to be de-energized when the power release gear returns to the home position. In the absence of the pawl releasing the ratchet, the power release gear is driven by the motor in a second direction opposite the first direction to cause the pawl to release the ratchet to permit the ratchet to move to the striker release position.

### CROSS-REFERENCE TO RELATED APPLICATION

This application claims the benefit of U.S. Provisional Application Ser. No. 63/602,346, filed Nov. 22, 2023, and the benefit of U.S. Provisional Application Ser. No. 63/602,351, filed Nov. 22, 2023, which are both incorporated herein by reference in their entirety.

### FIELD

The present disclosure relates generally to power door systems for motor vehicles. More particularly, the present disclosure is directed to a power door system equipped with a power latch assembly having a mono-directional motor and power release gear having sensor and hard stop features for stopping the power release gear during powered releasing of a pawl relative to a ratchet of the power latch assembly during normal release, as well as having bi-directional rotation for emergency release.

### BACKGROUND

This section provides background information related to closure latches and is not necessarily prior art to the closure latch of the present disclosure.

In view of increased consumer demand for motor vehicles equipped with advanced comfort and convenience features, many current vehicles are now provided with power actuated latch assemblies operable via passive keyless entry systems to permit powered locking and powered release of the latch assembles without the use of traditional manual entry mechanisms. Although such power actuated latch assemblies provide desired functionality under normal operating conditions, further advancements are desired to ensure features of the power actuated latch assemblies attain and retain their intended position and functionality, including during emergency conditions, such as a crash condition, while also having minimal components and being economical in manufacture.

In view of the above, there remains a desire to develop alternative power door latch assemblies which address and overcome limitations associated with known power door latch assemblies to provide enhanced functionality, while minimizing cost and complexity associated with such advancements.

### SUMMARY

This section provides a general summary of the disclosure and is not intended to be considered as a comprehensive and exhaustive listing of its full scope or all of its aspects, features and objectives.

It is an aspect of the present disclosure to provide a closure latch assembly for a vehicle closure panel, with the closure latch assembly having a minimal number of components and being economical in manufacture.

A closure latch assembly for a vehicle closure panel is provided. The closure latch assembly has a power release gear configured to be driven by the motor from a home position to a release position and back to the home position and a latch mechanism including a ratchet and a pawl. The ratchet is moveable between a primary striker capture position and a striker release position. The pawl is moveable between a ratchet holding position, whereat the pawl holds the ratchet in the primary striker capture position, and a ratchet releasing position, whereat the pawl permits the ratchet to move to its striker release position. The motor, upon being energized in a first actuation, drives the power release gear in a first direction from the home position to the release position, whereupon the power release gear operably drives the pawl from the ratchet holding position to the ratchet releasing position such that the ratchet can move from the primary striker capture position to the striker release position. The motor, upon causing the pawl to move to the ratchet releasing position and the ratchet to move from the primary striker capture position to the striker release position, drives the power release gear in the first direction back to the home position.

In accordance with a further aspect, a sensor is configured to signal the motor to be de-energized when the power release gear is returned to the home position.

In accordance with a further aspect, a ratchet stop lug is fixed to the ratchet and a power release gear stop lug is fixed to the power release gear, wherein, in the absence of the sensor signaling the motor to be de-energized when the power release gear reaches the home position, the power release gear stop lug engages the ratchet stop lug to stop the power release gear from being driven beyond the home position.

In accordance with a further aspect, in the absence of the sensor signaling the motor to be de-energized when the power release gear returns to the home position, the ratchet is able to return from the striker release position to the primary striker capture position, whereat the pawl returns to the ratchet holding position.

In accordance with a further aspect, in the absence of the pawl moving from the ratchet holding position to the ratchet releasing position and the ratchet moving from the primary striker capture position to the striker release position upon the power release gear rotating in the first direction from the home position to the release position, the motor is energized in a second actuation to drive the power release gear in a second direction, whereupon the power release gear operably drives the pawl from the ratchet holding position to the ratchet releasing position such that the ratchet moves from the primary striker capture position to the striker release position.

In accordance with a further aspect, the power release gear exerts a first force on the pawl while rotating in the first direction and the power release gear exerts a second force on the pawl while rotating in the second direction, wherein the second force is greater than the first force.

In accordance with a further aspect, the power release gear rotates over first range of degrees while rotating in the first direction and the power release gear rotates over a second range of degrees while rotating in the second direction, wherein the second range of degrees is greater than the first range of degrees.

In accordance with a further aspect, in the absence of the pawl moving from the ratchet holding position to the ratchet releasing position and the ratchet moving from the primary striker capture position to the striker release position upon the power release gear rotating in the second direction to a release position, the motor is energized in a third actuation to drive the power release gear a second time in the first direction.

In accordance with a further aspect, the power release gear rotates over first range of degrees while rotating in the first direction during the first occurrence and over a second range of degrees while rotating in the second direction, the second range of degrees being greater than the first range of degrees, and wherein the power release gear rotates over a third range of degrees while rotating in the first direction during the second occurrence, the third range of degrees being the same or greater than the second range of degrees.

In accordance with a further aspect, the power release gear exerts a first force on the pawl while rotating in the first direction during the first occurrence and a second force on the pawl while rotating in the second direction, wherein the second force is greater than the first force, and the power release gear exerts a third force on the pawl while rotating in the first direction during the second occurrence, wherein the third force is equal to or greater than the second force.

In accordance with a further aspect, the motor is energized by a primary power source during the first actuation and by a back-up energy source during the second actuation.

In accordance with a further aspect, the motor is energized by a primary power source during the first actuation and by a back-up power source during the third actuation.

In accordance with a further aspect, the motor is energized by the back-up power source during the second actuation.

In accordance with a further aspect, a method of actuating a closure latch assembly in a normal operating condition and in an emergency operating condition is provided. The method includes: during the normal operating condition, powering a motor in a first actuation to rotate a power release gear in a first direction to operably move a pawl from a ratchet holding position to a ratchet releasing position to cause a ratchet to move from a primary striker capture position to a striker release position. If the pawl fails to move from the ratchet holding position to the ratchet releasing position during the normal operating condition, then, during the emergency operating condition, powering the motor in a second actuation to rotate the power release gear in a second direction, opposite the first direction, to operably move the pawl from the ratchet holding position to the ratchet releasing position to cause the ratchet to move from the primary striker capture position to the striker release position.

In accordance with a further aspect, the method further includes causing the power release gear to exert a first force on the pawl while rotating in the first direction and causing the power release gear to exert a second force on the pawl while rotating in the second direction, wherein the second force is greater than the first force.

In accordance with a further aspect, the method further includes causing the power release gear to rotate over first range of degrees while rotating in the first direction and causing the power release gear to rotate over a second range of degrees while rotating in the second direction, wherein the second range of degrees is greater than the first range of degrees.

In accordance with a further aspect, the method further includes, during the emergency operating condition, powering the motor in a third actuation after the second actuation to rotate the power release gear in the first direction to operably move the pawl from the ratchet holding position to the ratchet releasing position to cause the ratchet to move from the primary striker capture position to the striker release position.

In accordance with a further aspect, the method further includes causing the power release gear to exert a first force on the pawl while rotating in the first direction in response to the first actuation and causing the power release gear to exert a second force on the pawl while rotating in the second direction in response to the second actuation, with the second force being greater than the first force, and causing the power release gear to exert a third force on the pawl while rotating in the first direction in response to the third actuation, with the third force being equal to or greater than the second force.

In accordance with a further aspect, the method further includes causing the power release gear to rotate over first range of degrees while rotating in the first direction during the first actuation and causing the power release gear to rotate over a second range of degrees while rotating in the second direction, the second range of degrees being greater than the first range of degrees, and causing the power release gear to rotate over a third range of degrees while rotating in the first direction during the third actuation, the third range of degrees being equal to or greater than the second range of degrees.

In accordance with a further aspect, the method further includes powering the motor with a primary power source during the normal operating condition and powering the motor with a back-up power source during the emergency operating condition.

Further areas of applicability will become apparent from the description provided herein. As noted, the description and any specific examples in this summary are intended for purposes of illustration only and are not intended to limit the scope of the present disclosure.

### BRIEF DESCRIPTION OF THE DRAWINGS

The drawings described herein have been provided to illustrate selected embodiments and specific features thereof and are not intended to limit the scope of the present disclosure. The present disclosure will now be described by way of example only with reference to the attached drawings, in which:

FIG. 1 is a perspective view of a motor vehicle having vehicle closure panel equipped with a closure latch assembly constructed in accordance with multiple aspects of the disclosure;

FIG. 2 is a perspective view of a closure latch assembly of FIG. 1 in accordance with one aspect of the disclosure, showing a ratchet of the closure latch assembly in a primary striker capture position;

FIG. 2A is an exploded view of FIG. 2;

FIG. 3 is a perspective view of the ratchet illustrating a ratchet stop lug attached thereto, with a power release gear having a power release gear stop lug configured for selective engagement with ratchet stop lug;

FIG. 4A is a front side view of the closure latch assembly in a latched position corresponding to the ratchet being in the primary striker capture position;

FIG. 4B is a rear view of FIG. 4A;

FIGS. 5A and 5B are similar to FIGS. 4A and 4B, respectively, illustrating an initial stage of a motor of the closure latch assembly being energized to drive a power release gear from a home position in a first direction to a release position and a pawl being driven from a ratchet holding position to a ratchet releasing position;

FIGS. 6A and 6B are similar to FIGS. 5A and 5B, respectively, illustrating an initial stage of the ratchet being released to move from the primary striker capture position to a striker release position;

FIGS. 7A and 7B are similar to FIGS. 6A and 6B, respectively, illustrating the ratchet moved to the striker release position;

FIGS. 8A and 8B are similar to FIGS. 7A and 7B, respectively, illustrating the power release gear continuing rotation in the first direction toward a reset, home position;

FIGS. 9A and 9B are similar to FIGS. 8A and 8B, respectively, illustrating a sensor detecting the power release gear moved to the reset, home position, with the sensor signaling the motor to be de-energized to stop rotation of the power release gear;

FIGS. 10A and 10B are similar to FIGS. 8A and 8B, respectively, illustrating the power release gear moved to bring the power release gear stop lug into engagement with the ratchet stop lug in the absence of the sensor signaling the motor to be de-energized as a result of a sensor malfunction, thereby maintaining the pawl in proper position for return to the ratchet holding position upon return of the ratchet to the primary striker capture position;

FIGS. 11A and 11B are similar to FIGS. 10A and 10B, respectively, illustrating the ratchet returned under a force of impact of a striker to the primary striker capture position, with the pawl returned to the ratchet holding position during the sensor malfunction;

FIGS. 12A AND 12B illustrate a release failure of release of the pawl from the ratchet holding position to the ratchet releasing position during a first normal operation;

FIGS. 13A and 13B illustrate a second release operation under an emergency operation with the motor of the closure latch assembly being energized to drive the power release gear in a second direction opposite the first direction;

FIGS. 14A and 14B illustrate a third release operation under an emergency operation with the motor of the closure latch assembly being energized to drive the power release gear in the first direction opposite the second direction; and

FIG. 15 illustrates a flow diagram of a method of actuating a closure latch assembly in a normal operating condition and in an emergency operating condition in accordance with a further aspect of the disclosure.

### DETAILED DESCRIPTION OF EXAMPLE EMBODIMENTS

Example embodiments of a closure latch assembly for use in motor vehicle closure panels, such as doors, by way of example and without limitation, are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

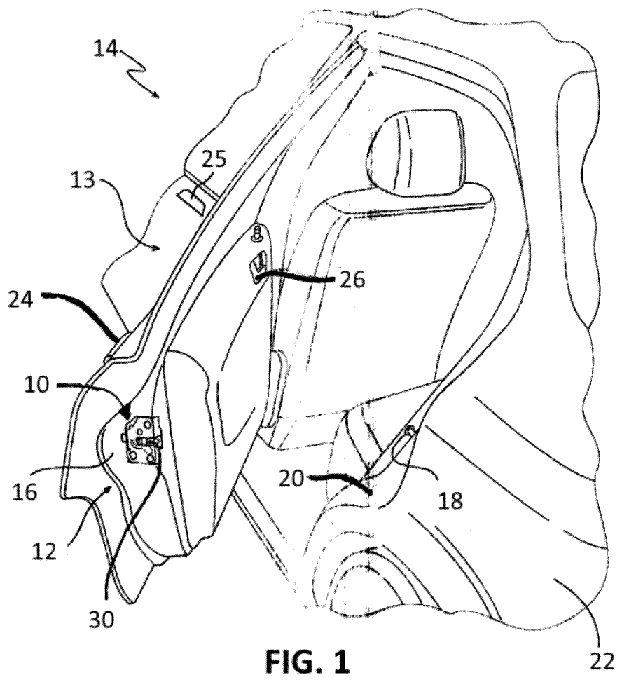

Referring initially to FIG. 1, a closure latch assembly, also referred to as closure latch or latch assembly 10, for a motor vehicle closure panel, such as a swing door, shown as a rear door 12, by way of example and without limitation, of a motor vehicle 14 is shown positioned along a shut face portion 16 of door 12 and is configured to releasably engage and capture a striker 18 secured to a vehicle body 22 to extend within a door opening 20 formed in vehicle body 22 in response to movement of door 12 from an open position to a closed position. Door 12 is shown to include an outside door handle 24 and an inside door handle 26, both of which are operatively connected (i.e., electrically and/or mechanically) to closure latch assembly 10. While not shown, it is understood that a similar closure latch assembly is provided in association with a front door 13 of vehicle 14 shown to include its own outside door handle 25.

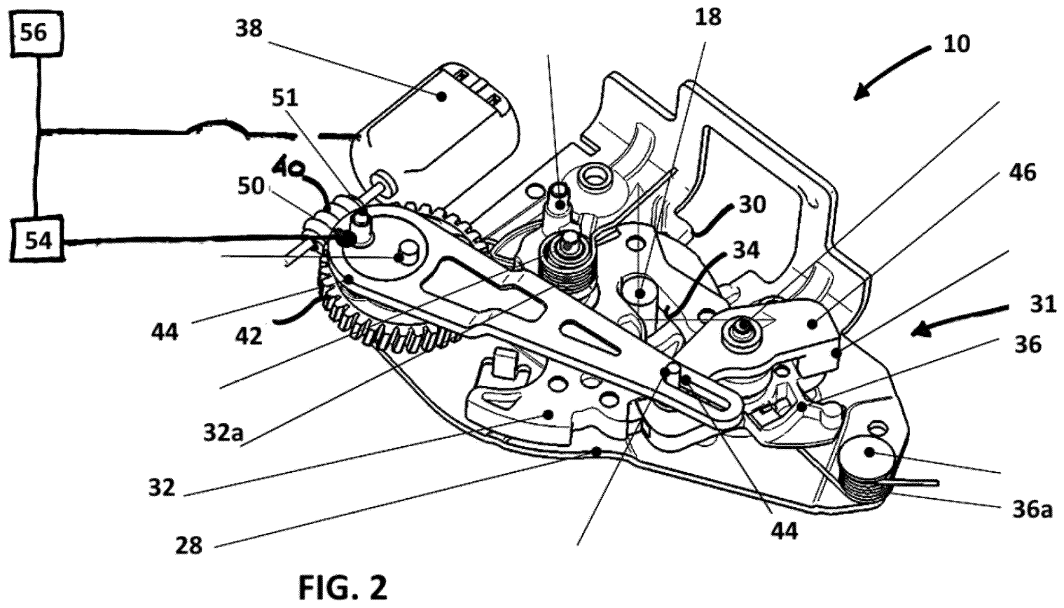

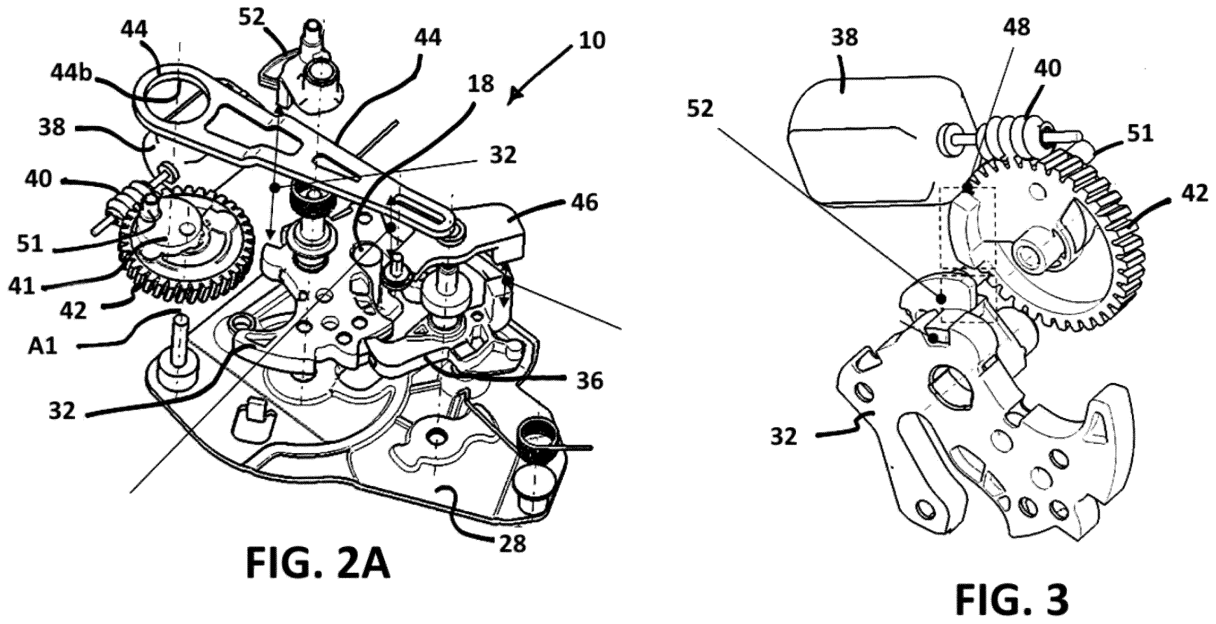

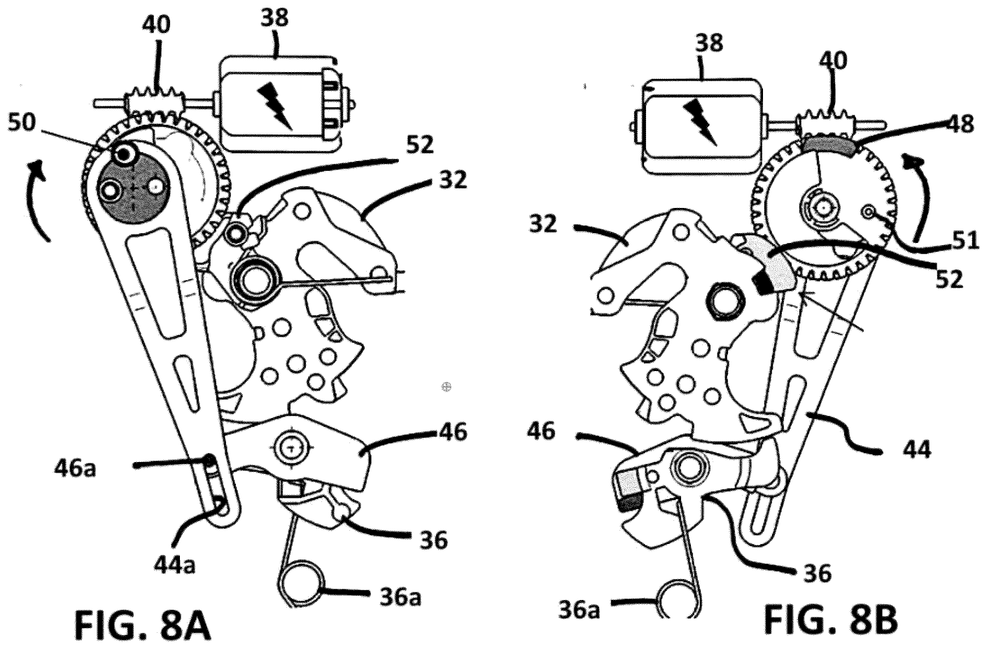

Referring now to FIGS. 2-5, a non-limiting example embodiment of closure latch assembly 10 and internal components, including a latch mechanism 31, thereof is shown, with latch mechanism 31 of closure latch assembly 10 shown in FIG. 2 in a closed, latched position. Latch mechanism 31 is shown having a ratchet 32 and a pawl 36. Ratchet 32 is pivotably mounted to a plate segment, also referred to as frameplate 28, of a latch housing and has a ratchet slot 34 alignable with a fishmouth slot 30 formed in frameplate 28. Ratchet 32 is moveable between a primary closed or “striker capture” position (FIGS. 2, 2A, 4A-5B, and FIGS. 11A-11B), whereat striker 18 is held within fishmouth slot 30 via being captured in ratchet slot 34, and an open or “striker release” position (FIGS. 7A through 10B), whereat striker 18 is free to be released from ratchet slot 34 and fishmouth slot 30. Ratchet 32 is biased by a ratchet biasing member 32a, such as a ratchet spring, toward its striker release position. Pawl 36 is pivotably supported for movement between a secured, ratchet holding position, also referred to as “closed” position, whereat pawl 36 locates and holds ratchet 32 in its striker capture position, and an unsecured, ratchet releasing position, also referred to as “open” position, whereat pawl 36 is positioned to permit ratchet 32 to move to its striker release position, such as under a bias imparted by ratchet spring on ratchet 32. A pawl biasing member 36a, such as a pawl spring, is operable to normally bias pawl 36 toward its open position.

A latch release mechanism can include a powered actuator 38, such as an electric motor, including a motor shaft with a worm gear 40 fixed thereto, and a power release gear 42 driven by worm gear 40 of electric motor 38 which functions to drive an actuator release lever 44, also referred to as actuator lever or power release link, or release link, via engagement of a cam member 41 fixed to power release gear 42 for eccentric rotation about a central axis A1 (FIG. 2A) of rotation of power release gear 42, with cam member 41 disposed within a receptacle 44b (FIG. 2A) of release lever 44. Release link 44, in turn, functions to drive a latch release lever 46, shown as a pawl lever, also referred to as release lever, which in turn drives pawl 36 from its ratchet holding position to its ratchet releasing position to provide a power releasing function of latch mechanism 31. Release lever 46 as a driven feature fixed thereto, shown as a pawl lever pin, also referred to as driven pin 46a, wherein driven pin 46a is received through an elongate slot 44a of release link 44 for lost motion movement therein. During movement of release link 44 in response to movement of power release gear 42 in the first direction D1 from the home position, driven pin 46a is drivingly engaged by an end of slot 44a, such that release lever 46a is driven to cause pawl 36 to move from the ratchet holding position, against the bias imparted by pawl biasing member 36a, to the ratchet releasing position.

A sensor 50, such as a hall sensor for example, is configured to in operable communication with the motor 38 to detect a home position of the power release gear 42, such as for example by detecting a magnet 51 secured to the power release gear 42. The sensor 50 is in communication with a controller 54 which is configured to control the operation of the motor 38. The controller 54 may be a combination of hardware and/or software, implemented for example in the form of a microprocessor and other circuit arrangement, or other electronic circuit arrangement in accordance with non-limiting examples. In operation, power release gear 42 is configured to be driven by the motor 38 in a single direction during normal operation (when no increased loading is imparted throughout latch mechanism 31 beyond the loading anticipated or otherwise expected during normal use), referred to as first direction D1, of rotation from a rest position, also referred to as home position, to a release position, and then continues rotation in the same first direction D1 to a reset position, corresponding with the home position. Accordingly, power release gear 42 only rotates in the first direction D1 to perform a release and reset function. During rotation in the first direction D1, power release gear 42 rotates over a first range of degrees, also referred to as first distance d1, from the rest position to the release position. Power release gear 42 operably (directly or indirectly through intervening components, i.e. actuator release lever 44 and latch release lever 46) exerts a first force F1 on pawl 36, while rotating in the first direction D1.

Ratchet has a ratchet stop lug 52, also referred to as safety block feature. Ratchet stop lug 52 can be formed of a separate piece of material from ratchet 32 and subsequently fixed thereto, as shown in FIGS. 2A and 3. Otherwise, it is contemplated herein that ratchet stop lug 52 can be formed as monolithic piece of material with ratchet 32, if desired. Regardless, ratchet stop lug 52 is fixed to ratchet 32 for conjoint movement therewith.

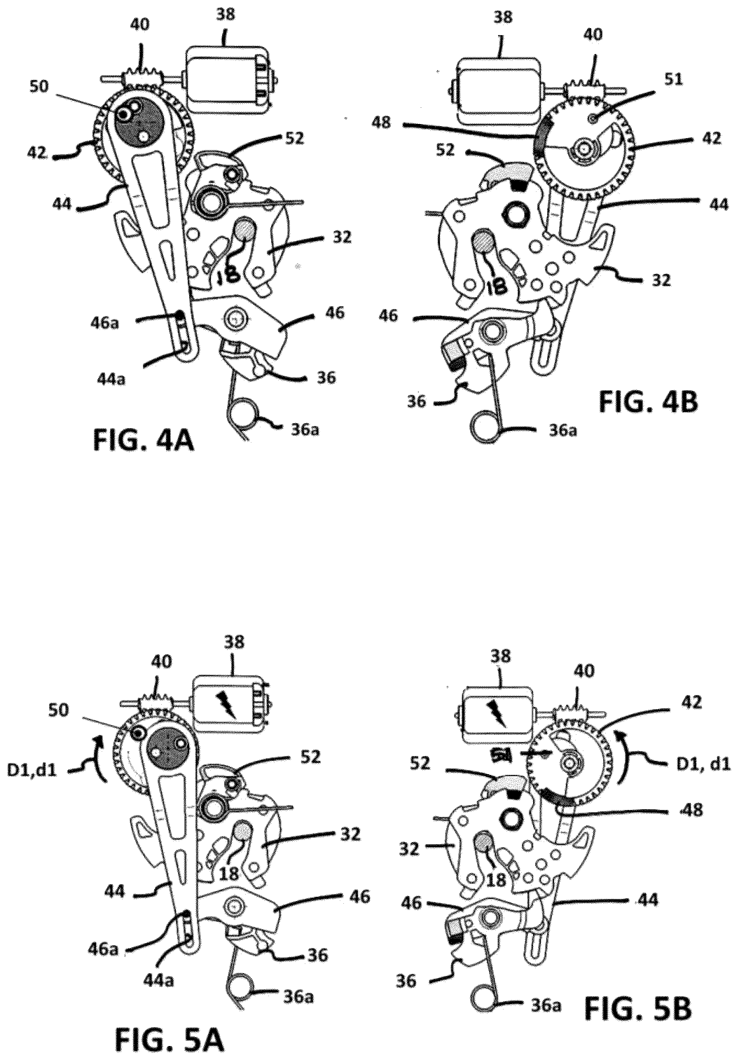

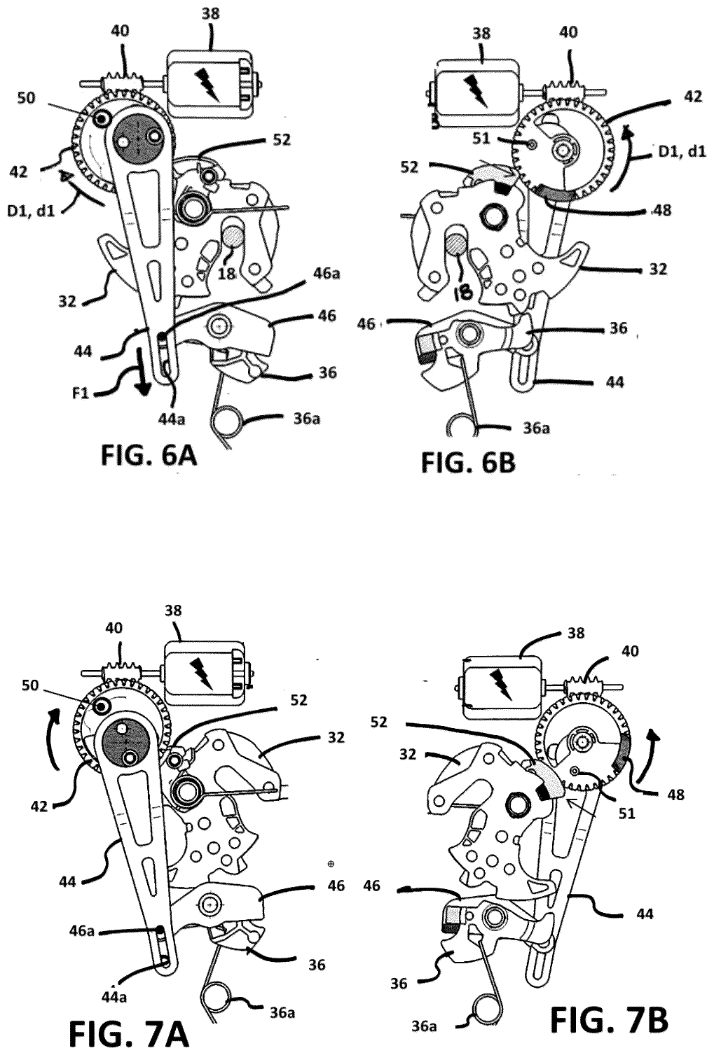

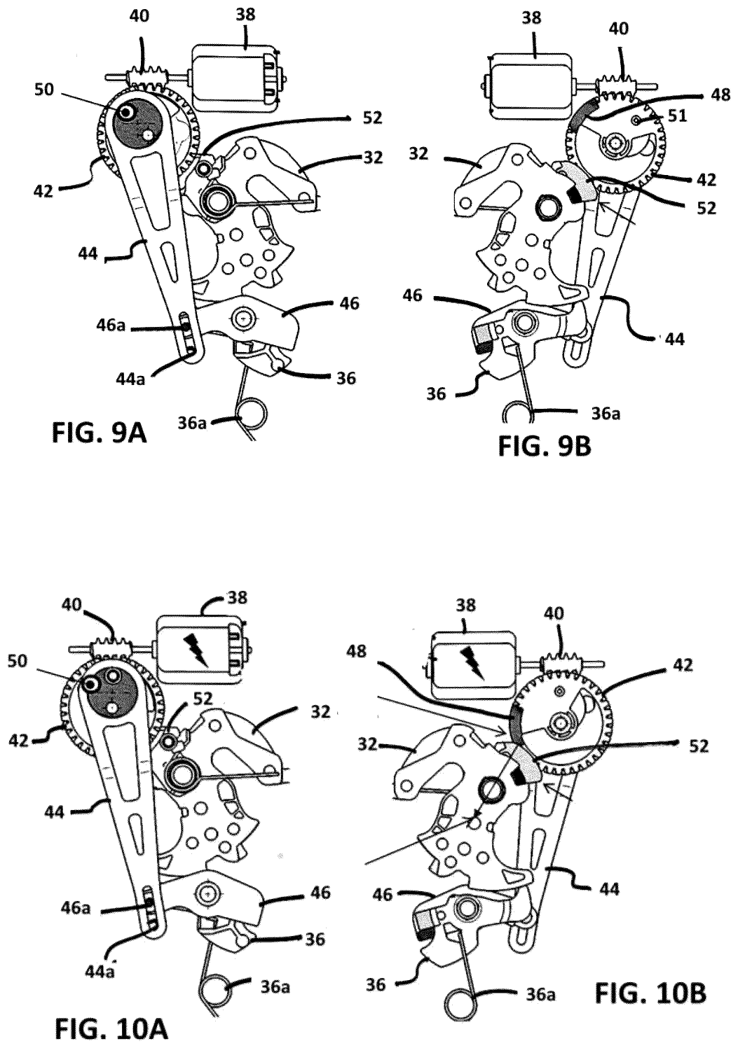

Power release gear 42, in normal operation, is configured to be driven by the motor 38, upon being energized in response to a release command, in the single first direction D1 of rotation from a rest position, also referred to as home position (FIGS. 4A and 4B), whereat pawl 36 is holding ratchet 32 is in the primary striker capture position, to a release position (FIGS. 5A and 5B), whereat pawl 36 is intended to be moved against the bias imparted by pawl biasing member 36a to the ratchet releasing position and ratchet 32 is intended to be free to move under the bias imparted by ratchet biasing member 32a to the striker releasing position. Then, power release gear 42 continues rotation in the same first direction D1 (FIGS. 6A through 9B) back to the reset position, corresponding with the home position (FIGS. 9A and 9B). The power release gear 42 has a power release gear stop lug 48 fixed thereto, also referred to as safety block feature, which only serves to function in the event of a malfunction of sensor 50 provided to detect power release gear 42 being returned to its home position. Sensor 50 is configured to signal the motor 38, via controller 54, to be de-energized when the power release gear 42 reaches the home position. Sensor 50 can be configured to detect the position of a magnet 51 fixed to power release gear 42, by way of example and without limitation, thereby enabling sensor 50 to detect when power release gear 42 is in a desired position, such as the home position, whereat sensor 50 signals motor 38 to be de-energized.

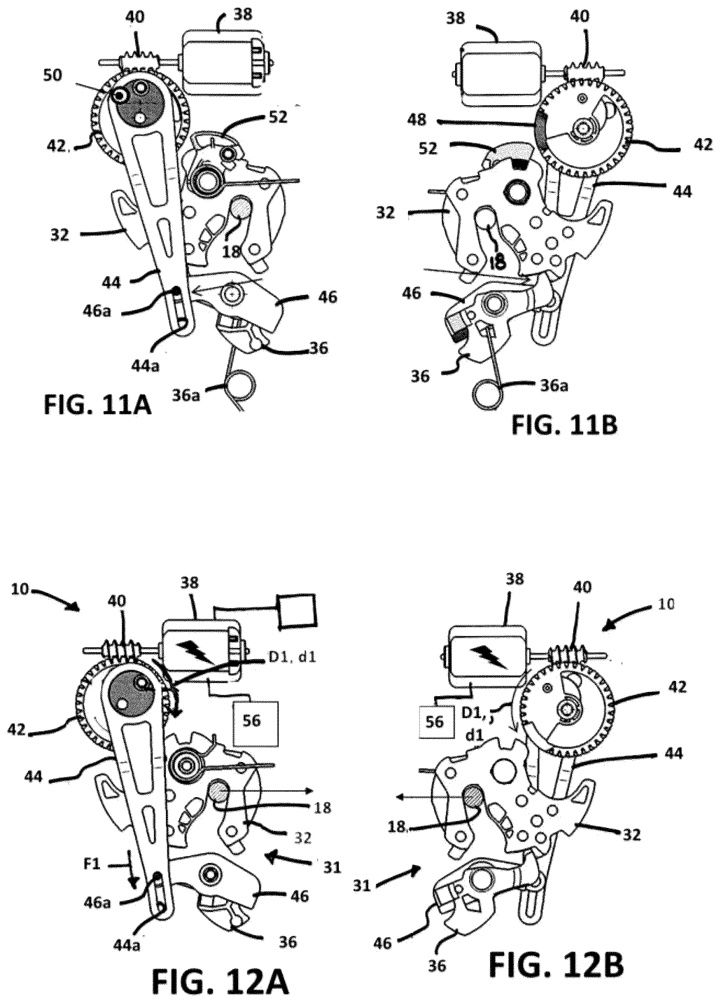

In the absence of the sensor 50 signaling the motor 38 to be de-energized when the power release gear 42 returns from the release position back to the home position, such as may occur if sensor 50 and/or magnet 51 becomes non-functional, such via becoming damaged, by way of example and without limitation, the power release gear stop lug 48 engages the ratchet stop lug 52 fixed to ratchet 32 (FIG. 10B) to stop the power release gear 38 from being continuously driven in the first direction D1 beyond and away from the home position. As such, with power release gear 38 being retained in the home position, as shown in FIGS. 11A and 11B, the ratchet 32 remains free to return to the primary striker capture position, with the pawl 36 returning under the bias imparted by pawl biasing member 36a to the ratchet holding position, upon closing the vehicle closure panel 12. After the ratchet 32 has been returned to a fully closed position, such that ratchet stop lug 52 is moved out of the path of travel of the power release gear stop lug 48 as shown in FIG. 11B, upon a subsequent activation of motor 38 in the direction D1, d1 to power release the latch again, the power release gear 42 will not be hindered by the that ratchet stop lug 52. As a result, latch 10 in one possible configuration is configured having a mono-directional power release chain where the rotation of the power release gear, and the rotation of the motor 38 may be provided during a normal mode (e.g. a non-emergency mode) in a single direction, shown illustratively as direction D1, d1. As a result, control of the motor 38 requiring a H-bridge for example is not required as the motor 38 is controlled only be provided on/off power signals, and not a reversal in power supply polarity, thus reducing electronics and control features. Also, a reset or return spring is not required to return to a home position and a backdrive of the motor 38 under this spring bias is also not required, thus eliminating a spring component as well as a hard stop/impact reset noise at ever deactivation of the motor 38 caused by a reset spring.

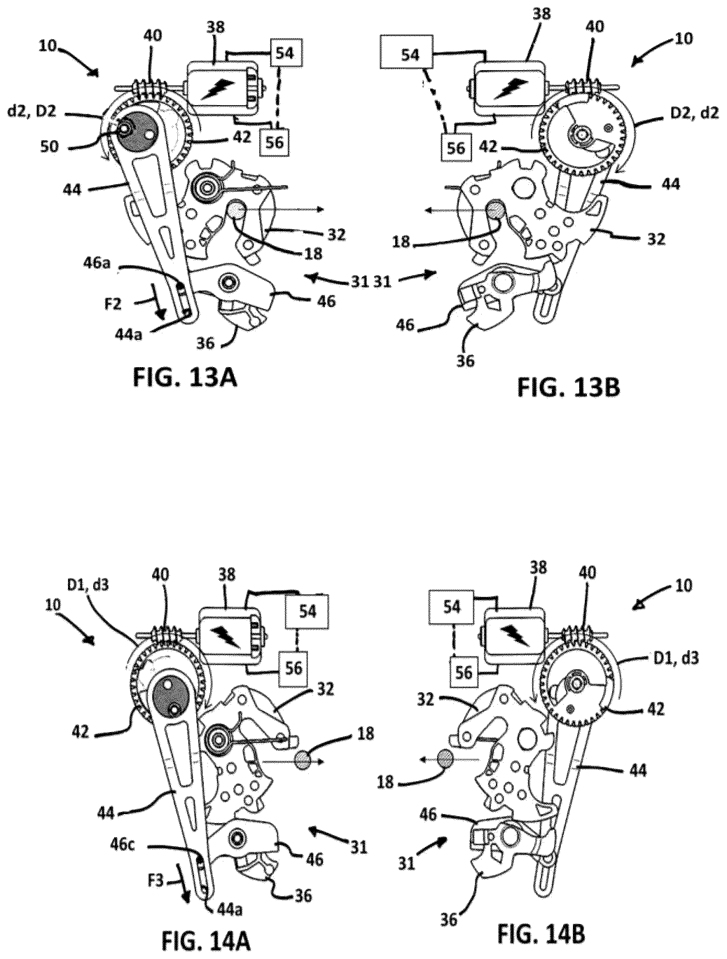

Further, in the absence of the pawl 36 moving from the ratchet holding position to the ratchet releasing position and the ratchet 32 moving from the primary striker capture position to the striker release position upon the power release gear 42 rotating in the first direction D1 over the first distance d1 during normal operation (FIGS. 12A and 12B), as discussed above for FIGS. 5A and 5B, the controller 54 (FIG. 2) signals the motor 38 to become energized to reverse direction of rotation and drive the power release gear 42 in a second direction D2 (FIG. 13A) opposite the first direction D1. During rotation of power release gear 42 in the second direction D2, power release gear 42 operably (directly or indirectly though intervening components, i.e. release link, also referred to as actuator release lever 44, and release lever, also referred to as latch release lever 46) exerts a second force F2 (FIG. 13A) on pawl 36, thereby moving pawl 32 against the bias imparted by pawl biasing member 36a from the ratchet holding position to the ratchet releasing position such that the ratchet 32 moves under the bias imparted by ratchet biasing member 32a from the primary striker capture position to the striker release position. The absence of the pawl 36 moving from the ratchet holding position to the ratchet releasing position and the absence of ratchet 32 moving from the primary striker capture position to the striker release position upon the power release gear 42 rotating in the first direction D1 during normal operation (FIGS. 12A and 12B) may be determined, for example, by the sensor 50 not detecting the power release gear 42 returning to the home position after energization of the motor 38, and/or by the position of the pawl 36 not being detected by a sensor as having moved to the ratchet releasing position, and/or by the ratchet 32 as having not being detected by a sensor having rotated to the open, striker releasing position and/or the motor 38 being detected by a sensor to be in a stall condition. During rotation in the second direction D2, power release gear 42 rotates over a second range of degrees, also referred to as second distance d2, from the rest position to the release position, wherein the second distance d2 is greater than the first distance d1. With second distance d2 being greater than first distance d1, the second force F2 is greater than the first force F1, thus, overcoming the resistance that prevented intended release of closure latch assembly 10 during the first normal release attempt of FIGS. 12A and 12B. The increased distance d2 traveled by power release gear 42 generates an increase in inertia, which at least in part contributes to the increase in second force F2 relative the first force F1. In order to increase travel distance of the power release gear 42 during motor reversal operation, such as for example which may occur during emergency condition operation, the signal from sensor 50 may be ignored by the controller 54 so as not to stop the rotation of the power release gear 42 at the home position to allow the power release gear 42 to fully develop rotational speed and inertia from its previous stopped position e.g. at stall position.

If, for any reason, closure latch assembly 10 remains in it latched state after completion of the second actuation depicted in FIGS. 13A and 13B, which can be readily determined by aforementioned position detection sensors and controller 54, a third actuation of motor 38 can be performed via a signal from sensor 50. As shown in FIGS. 14A and 14B, the third actuation causes motor 38 to again reverse directions to rotate in the first direction D1, whereupon the power release gear 42 operably (directly or indirectly though intervening components, i.e. actuator release lever 44 and latch release lever 46) exerts a third force F3 on pawl 36, thereby moving pawl 32 from the ratchet holding position to the ratchet releasing position such that the ratchet 32 moves from the primary striker capture position to the striker release position. During rotation in the first direction D1, power release gear 42 rotates over a third range of degrees, also referred to as third distance d3, from the rest position to the release position, wherein the third distance d3 is greater than the first distance d1, and is at least the same as or preferably greater than the second distance d2. With third distance d3 being greater than first distance d1, and equal to or greater than the second distance d2, the third force F3 is greater than the first force F1, and equal to or greater than the second force F2, thus, maximizing opportunity of overcoming the resistance that prevented intended release of closure latch assembly 10 during the normal release of FIGS. 12A and 12B. The increased distance d3 traveled by power release gear 42 generates an increase in inertia, which at least in part contributes to the increase in third force F3 relative the first force F1, and desirably greater than the second force F2.

In accordance with a further aspect, the power used to power motor 38 during the second and third actuations to drive power release gear 42 in the emergency condition can be provided by a back-up power source 56 other than the main vehicle battery, also referred to as primary power source, used during normal operation. The back-up power source 56 can be provided as a fully charged super capacitor, thereby having a full charge of power, which may not be available from the main vehicle battery, particularly in an emergency condition, e.g. crash condition. The back-up power source 56 can be arranged in operable communication with sensor 50 and/or a vehicle ECU 54, as desired.

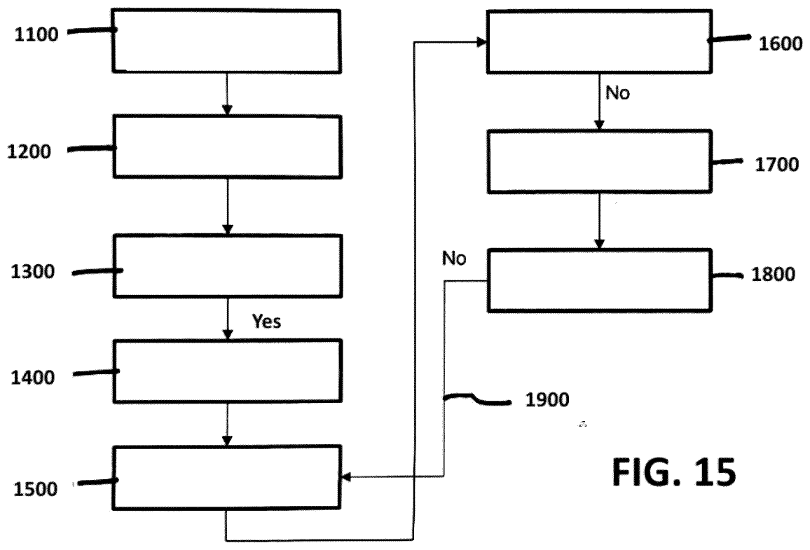

In FIG. 15, a flow diagram illustrates a method 1000 of actuating a closure latch assembly 10 in a normal operating condition and in an emergency operating condition in accordance with another aspect of the disclosure. The method 1000 includes a step 1100 of actuating the closure latch assembly 10 in a normal mode, as discussed above and illustrated in FIGS. 12A and 12B. During normal mode of operation, a step 1200 of powering the motor 38 to rotate in a mono-direction is included, thereby rotating power release gear 42 over a first distance d1 in a first direction D1, whereupon a first force F1 is imparted throughout latch mechanism 31. Then, if a sensor 50 detects an emergency condition, such as a crash condition, at a step 1300, whereat latch mechanism 31 remains in a latched state, a step 1400 of actuating the closure latch assembly 10 in an emergency mode, as discussed above and illustrated in FIGS. 13A and 13B, is performed, whereupon motor 38 is caused to rotate in a second direction at step 1500, thereby driving power release gear 42 over a second distance d2 in a second direction D2, whereupon a second force F2 is imparted throughout latch mechanism 31. Second distance d2 is greater than first distance d1, and thus, second force F2 is greater than first force F1, at least in part due to an increase in inertia. A next step 1600 determines if closure latch assembly 10 is moved from the latched state to an unlatched state. If the closure latch assembly 10 is detected as remaining in the latched state, such as via sensor 50, a step 1700 of powering the motor 38 to rotate in the first direction (FIGS. 14A and 14B), thereby rotating power release gear 42 over a third distance d3 in the first direction D1 is performed, whereupon a third force F3 is imparted throughout latch mechanism 31, with third force F3 being equal to or greater than second force F2. A next step 1800 determines if closure latch assembly 10 is moved from the latched state to an unlatched state. If the closure latch assembly 10 is detected as remaining in the latched state, such as via sensor 50, a step 1900 returns to step 1500 to repeat the operation thereof, which can continue until closure latch assembly 10 is unlatched.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a vehicle closure panel, comprising:
a motor;
a power release gear configured to be driven by said motor from a home position to a release position and back to the home position; and
a latch mechanism including a ratchet and a pawl, the ratchet being moveable between a primary striker capture position and a striker release position, the pawl being moveable between a ratchet holding position, whereat the pawl holds the ratchet in the primary striker capture position, and a ratchet releasing position, whereat the pawl permits the ratchet to move to its striker release position,
wherein the motor, upon being energized in a first actuation, drives the power release gear in a first direction from the home position to the release position, whereupon the power release gear operably drives the pawl from the ratchet holding position to the ratchet releasing position such that the ratchet can move from the primary striker capture position to the striker release position,
wherein the motor, upon causing the pawl to move to the ratchet releasing position and the ratchet to move from the primary striker capture position to the striker release position, drives the power release gear in the first direction back to the home position.

2. The closure latch assembly of claim 1, further including a sensor configured to signal said motor to be de-energized when said power release gear is returned to the home position.

3. The closure latch assembly of claim 2, further including a ratchet stop lug fixed to said ratchet and a power release gear stop lug fixed to said power release gear, wherein, in the absence of said sensor signaling said motor to be de-energized when said power release gear reaches the home position, said power release gear stop lug engages said ratchet stop lug to stop said power release gear from being driven beyond the home position.

4. The closure latch assembly of claim 3, wherein, in the absence of said sensor signaling said motor to be de-energized when said power release gear reaches the home position, said ratchet is able to return from the striker release position to the primary striker capture position, whereat the pawl returns to the ratchet holding position.

5. The closure latch assembly of claim 1, wherein, in the absence of the pawl moving from the ratchet holding position to the ratchet releasing position and the ratchet moving from the primary striker capture position to the striker release position upon the power release gear rotating in the first direction from the home position to the release position, said motor is energized in a second actuation to drive the power release gear in a second direction, whereupon the power release gear operably drives the pawl from the ratchet holding position to the ratchet releasing position such that the ratchet moves from the primary striker capture position to the striker release position.

6. The closure latch assembly of claim 5, wherein said power release gear exerts a first force on said pawl while rotating in the first direction and a second force on said pawl while rotating in the second direction, said second force being greater than said first force.

7. The closure latch assembly of claim 5, wherein said power release gear rotates over first range of degrees while rotating in the first direction and over a second range of degrees while rotating in the second direction, the second range of degrees being greater than the first range of degrees.

8. The closure latch assembly of claim 5, wherein in the absence of the pawl moving from the ratchet holding position to the ratchet releasing position and the ratchet moving from the primary striker capture position to the striker release position upon the power release gear rotating in the second direction, said motor is energized in a third actuation to drive the power release gear a second time in the first direction.

9. The closure latch assembly of claim 8, wherein said power release gear rotates over first range of degrees while rotating in the first direction during the first occurrence and over a second range of degrees while rotating in the second direction, the second range of degrees being greater than the first range of degrees, and wherein the power release gear rotates over a third range of degrees while rotating in the first direction during the second occurrence, the third range of degrees being the same or greater than the second range of degrees.

10. The closure latch assembly of claim 9, wherein said power release gear exerts a first force on said pawl while rotating in the first direction during the first occurrence and a second force on said pawl while rotating in the second direction, said second force being greater than said first force, and said power release gear exerts a third force on said pawl while rotating in the first direction during the second occurrence, said third force being equal to or greater than said second force.

11. The closure latch assembly of claim 5, wherein said motor is energized by a primary power source during the first actuation and by a back-up energy source during the second actuation.

12. The closure latch assembly of claim 8, wherein said motor is energized by a primary power source during the first actuation and by a back-up power source during the third actuation.

13. The closure latch assembly of claim 12, wherein said motor is energized by the back-up power source during the second actuation.

14. A method of actuating a closure latch assembly in a normal operating condition and in an emergency operating condition, comprising:
during the normal operating condition, powering a motor in a first actuation to rotate a power release gear in a first direction to operably move a pawl from a ratchet holding position to a ratchet releasing position to cause a ratchet to move from a primary striker capture position to a striker release position, and, if the pawl fails to move from the ratchet holding position to the ratchet releasing position; and
during the emergency operating condition, powering the motor in a second actuation to rotate the power release gear in a second direction to operably move the pawl from the ratchet holding position to the ratchet releasing position to cause the ratchet to move from the primary striker capture position to the striker release position.

15. The method of claim 14, further including causing said power release gear to exert a first force on said pawl while rotating in the first direction and a second force on said pawl while rotating in the second direction, said second force being greater than said first force.

16. The method of claim 14, further including causing said power release gear to rotate over first range of degrees while rotating in the first direction and over a second range of degrees while rotating in the second direction, the second range of degrees being greater than the first range of degrees.

17. The method of claim 14, further including, during the emergency operating condition, powering the motor in a third actuation after the second actuation to rotate the power release gear in the first direction to operably move the pawl from the ratchet holding position to the ratchet releasing position to cause the ratchet to move from the primary striker capture position to the striker release position.

18. The method of claim 17, further including causing said power release gear to exert a first force on said pawl while rotating in the first direction in response to the first actuation and a second force on said pawl while rotating in the second direction in response to the second actuation, said second force being greater than said first force, and to exert a third force on said pawl while rotating in the first direction in response to the third actuation, the third force being equal to or greater than the second force.

19. The method of claim 17, further including causing said power release gear to rotate over first range of degrees while rotating in the first direction during the first actuation and over a second range of degrees while rotating in the second direction, the second range of degrees being greater than the first range of degrees, and causing the power release gear to rotate over a third range of degrees while rotating in the first direction during the third actuation, the third range of degrees being the same or greater than the second range of degrees.

20. The method of claim 14, further including powering the motor with a primary power source during the normal operating condition and powering the motor with a back-up power source during the emergency operating condition.
